(19) United States
(12) Patent Application Publication
(10) Pub. No.: US 2017/0334021 A1
(43) Pub. Date: Nov. 23, 2017

(54) SYSTEMS FOR AND METHOD OF WELDING USING BEAM SHAPING MEANS AND SHIELDING MEANS

(71) Applicant: TOYOTA MOTOR EUROPE, Brussels (BE)

(72) Inventor: Akira TSUKUI, Woluwe-Saint-Lambert (BE)

(73) Assignee: TOYOTA MOTOR EUROPE, Brussels (BE)

(21) Appl. No.: 15/535,869

(22) PCT Filed: Dec. 15, 2014
(86) PCT No.: PCT/EP2014/077816

§ 371 Date: Jun. 14, 2017

(51) Int. Cl. B23K 26/073; H01M 10/04; B23K 26/20; B23K 26/067; B23K 26/06; B23K 26/082; H01M 10/0525; B23K 26/066; B23K 101/36

(52) U.S. Cl. CPC B23K 26/073; H01M 10/0525; H01M 10/049; B23K 26/206; B23K 26/066; B23K 26/067; B23K 26/0648; B23K 26/082; B23K 2201/36

(57) ABSTRACT

A laser welding system is provided. The laser welding system includes a laser source configured to produce a laser beam, beam shaping means configured to form a beam profile different from that of the laser beam, and shielding means configured to shield at least a portion of the shaped beam profile.

### FIELD OF THE DISCLOSURE

The present disclosure is related to systems and methods for welding, and more particularly to laser welding using optical elements and shields to form a shaped welding profile.

### BACKGROUND OF THE DISCLOSURE

In manufacturing of electronic devices, e.g., batteries, fuel cells, etc., component design often involves various pieces (e.g., two or more thin metal sheets) being assembled together by welding.

Typically, metal sheets are positioned together and placed on a welding support. A welding device (e.g., laser, electron beam/plasma, arc-welder, and/or other similar devices) can then be used to perform a welding operation.

For example, when enclosing a battery (e.g., lithium-ion) within a case and cover, the inner portion of the battery may be assembled or placed within the case, the cover put in place, and a laser welding operation carried out to affix the case and cover to seal closed the battery.

However, in some circumstances, where laser energy enters the inner portions of the battery, undesirable effects can occur (e.g., damage to an electrode). In addition, it is possible that the welding operation does not completely seal the case to the cover, and therefore problems can occur.

According to some available techniques, a laser beam formed via a fiber laser is used to create multiple heat source points in a symmetric cross shape using optical elements (e.g., diffractive optical elements), and a welding operation carried out with the resulting multi-point beam. For example, a configuration wherein a primary heat source point is created in a center portion surrounded at four corners by sub heat source points, thereby forming a rectangular profile. See for example, Japanese patent application Japanese patent application JP2014123850, filed Jun. 16, 2014.

### SUMMARY OF THE DISCLOSURE

Currently higher energy consuming fiber lasers are typically implemented for performing a variety of laser welding operations based on their smaller spot size. However, such fiber lasers can have an undesirably high operation cost per unit power and may emit in an undesirable wavelength for welding certain materials.

Moreover, available diode lasers, while consuming smaller amounts of energy, have a spot size that is typically undesirable for performing a welding operation within reduced clearance areas where the risk of damage to surrounding areas (e.g., internal battery components) by intrusion of a welding laser beam is elevated.

It has been determined that prior systems lack an effective and efficient system for welding where a reduction in both power and probability of undesirable effects can be achieved. It is accordingly a primary object of the disclosure to provide systems and methods that overcome the deficiencies of the currently available systems and methods.

According to embodiments of the present disclosure, a laser welding system is provided. The system includes a laser source configured to produce a laser beam having a beam profile, beam shaping means configured to form a shaped beam profile different than the beam profile, and shielding means configured to shield at least a portion of the shaped beam profile. For example, at least 20 percent of the overall shaped beam profile area may be shielded by the shielding means.

By providing a laser welding system as described above, it becomes possible to use laser sources of various beam profiles and to shape the laser beam profile according to adjustment/placement of the shielding means. Therefore, it becomes possible to use laser sources that have lower energy consumption per unit power output, but would otherwise be unsuitable for welding, e.g., a diode laser in reduced clearance areas.

The laser source may include a diode laser, preferably a diode laser having a spot size between 200 μm and 800 μm, better between 300 and 500 μm. Further, the laser beam may have a wavelength of between 600 nm and 1200 nm, better between 800 nm and 900 nm.

The beam shaping means may include a diffractive optical element, and/or the shaped beam profile comprises a top-hat profile.

According to some embodiments, directing means configured to direct the shielded beam profile along a weld line of a target to perform a laser weld may be provided.

The shielded portion of the shaped laser beam profile may comprise at least 50 percent of the overall shaped beam profile area.

The shielding means may include at least one laser absorbing material.

A shape of the shielding means can be selected from among triangular and rectangular.

According to some embodiments, the shielding means may include two shields of triangular shape.

The shielding means can be configured to form a shielded beam profile selected from one of a cross or a line.

According to some embodiments, the system may include adjusting means configured to adjust the shielding means based on a location along a weld line of a target.

According to further embodiments, a method for laser welding, is provided. The method includes shaping a laser beam to form a desired laser beam profile, adjusting at least one laser shield such that at least a portion an area of the shaped laser beam profile is shielded to form a welding profile, and directing the welding profile in a travel direction along a weld line of a target so as to perform a welding operation. The portion may be 20 percent or more of the area.

By providing a laser welding method as described above, it becomes possible to use laser sources of various beam profiles and to shape the laser beam profile according to adjustment of the shields. Therefore, it becomes possible to use laser sources that have lower energy consumption per unit power output, but would otherwise be unsuitable for welding, e.g., a diode laser in reduced clearance areas.

The adjusting may result in further shaping of the desired laser beam profile, and may result in formation of a top-hat profile.

The target can be an elongate battery case and cover, preferably for a lithium ion battery.

The adjusting may be carried out based on a location along the weld line.

According to still further embodiments, a laser welding system is provided. The system includes a laser source configured to produce a laser beam having a beam profile, a beam shaper configured to form a shaped beam profile different from the beam profile of the laser beam, and at least one laser shield configured to shield at least a portion of the shaped beam profile. According to some embodiments, at least 20 percent of the overall shaped beam profile area may be shielded by the at least one laser shield.

The laser source may comprise a diode laser and the diode laser has a spot size between 200 μm and 800 μm.

The laser beam may have a wavelength of between 600 nm and 1200 nm, better between 800 nm and 900 nm.

The beam shaper may include a diffractive optical element, and the shaped beam profile may be a top-hat profile.

The system may further include one or more optical elements and a controller configured to direct the shielded beam profile along a weld line of a target to perform a laser weld.

The shielded portion of the laser beam profile may comprise at least 50 percent of the overall shaped beam profile area. The at least one laser shield may include at least one laser absorbing material.

A shape of the at least one laser shield is selected from among triangular and rectangular.

The at least one laser shield may include two laser shields of triangular shape.

The at least one laser shield can be configured to form a shielded beam profile selected from one of a cross or a line.

According to some embodiments, the system may include an adjuster configured to adjust the at least one laser shield based on a location along a weld line of a target. The adjuster may include one or more servo motors configured to move the shield(s) to change the shape of the shielded beam profile.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles thereof.

### BRIEF DESCRIPTION OF THE DRAWINGS

FIG. 1A shows a prior art welding profile;

FIG. 1B is a diagram showing a scanning technique for welding using the welding profile of FIG. 1A;

FIG. 1C is an exemplary representation of a Gaussian fiber-laser laser beam and a resulting profile after beam splitting;

FIG. 1D is an exemplary representation of a Gaussian diode-laser laser beam and a resulting profile after beam splitting;

FIG. 2A shows an exemplary welding system according to embodiments of the present disclosure;

FIG. 2B is an exemplary representation of a target in proximity to the welding system shown at FIG. 2A;

FIG. 3A shows an exemplary Gaussian diode laser spot;

FIG. 3B shows a resulting shaped laser beam profile following transformation of the diode laser spot of FIG. 3A;

FIG. 3C is an exemplary laser shield configuration that may be implemented with regard to the shaped laser beam profile of FIG. 3B;

FIGS. 4A and 4B show exemplary configurations of one or more laser shields with regard to a shaped laser beam profile of FIG. 3B;

FIG. 5 is a graph showing absorption ratios at various wavelengths for various materials that may be welded;

FIG. 6 is a flowchart highlighting an exemplary method according to embodiments of the present disclosure.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

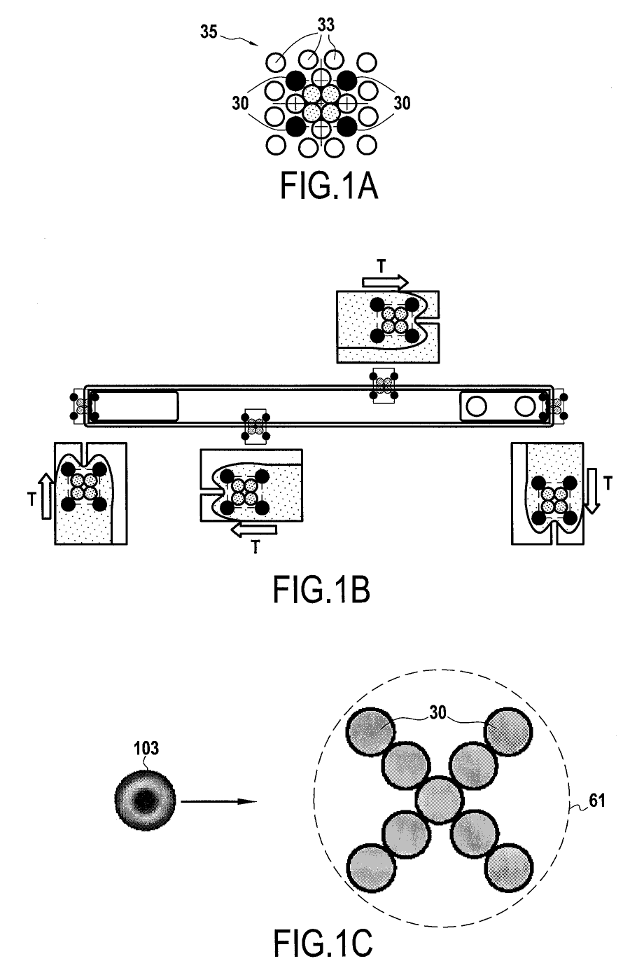

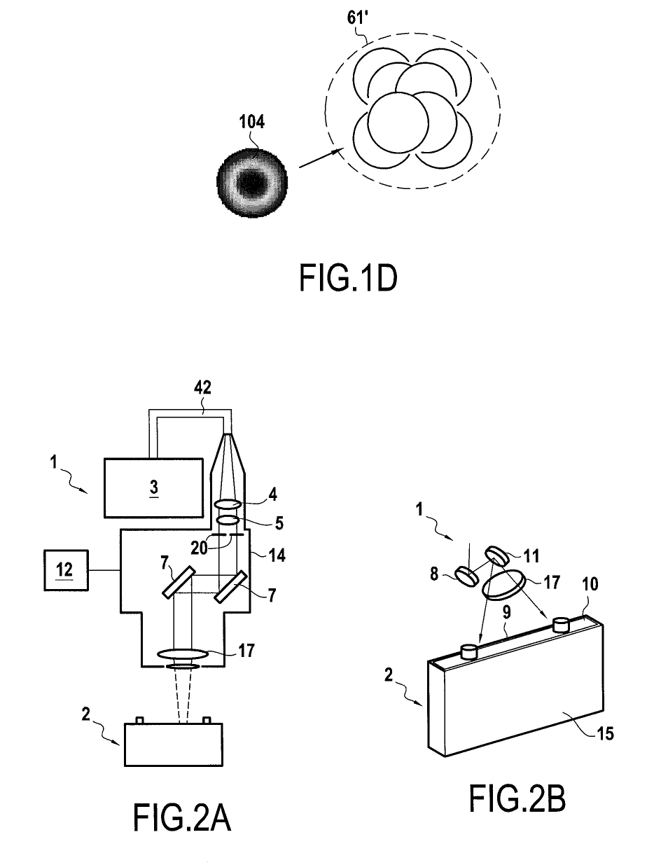

FIG. 1A shows a prior art welding profile, while FIG. 1B is a diagram showing a scanning technique for welding using the welding profile of FIG. 1A. As described above, at least five heat source points 30 have been used in prior art systems, and this can result in excess energy consumption, as well as production of various undesirable “ghost beams” 33.

When scanning the weld line using the profile 35 of FIG. 1A, as shown at FIG. 1B, it is possible that ghost beams 33 may pass between the gap to be welded and enter the internal portion of the target 2. This can lead to undesirable effects.

FIG. 1C shows a prior art Gaussian fiber laser beam 103 that is then split to form the heat source points 30 in a cross-type welding profile 61. While such a profile 61 is known in the prior art, such profiles are formed using fiber lasers having a spot size of approximately 50 μm.

FIG. 1D demonstrates the result of splitting a Gaussian diode laser beam 104, which has a wider spot size (e.g., greater than 400 μm) in attempting to obtain a profile similar to that obtained using fiber laser beam 103. Resulting profile 61′ is generally undesirable for welding in restricted spaces, and can result in damage to various portions of a part to be welded due to the non-uniform distribution of energy, among others.

FIG. 2A shows an exemplary welding system 1 configured to remedy the above problems according to embodiments of the present disclosure while FIG. 2B is an exemplary representation of a target in proximity to the welding system shown at FIG. 2A. Welding system 1 may include a laser source 3, a collimator 4, a beam modifier 5 (e.g., a diffractive optical element (DOE)), a directing unit 14, one or more shields 20, and a controller 12. One of skill in the art will understand that more or fewer components may be present without departing from the scope of the present disclosure.

Laser source 3 includes any suitable device for providing a laser beam, for example, a laser oscillator. Laser source 3 may provide laser light at any wavelength (e.g., between about 600 nm and 1200 nm, better between 800 nm and 900 nm) and energy level suitable for welding materials associated with target 2. For example, suitable laser sources include a diode laser.

Collimator 4 may be optionally provided within welding system 1, and can be configured to collimate laser light provided by laser source 3. For example, laser light provided by laser source 3 may pass through a delivery medium (e.g., optical fiber) to arrive at a desired location. Upon exiting the delivery medium, the laser light may be collimated via collimator 4 to desirably align the light waves and narrow the beam before passing through additional optical elements, e.g., beam modifier 5. Collimator 4 may therefore be any lens, mirror, or other suitable element for collimating laser light.

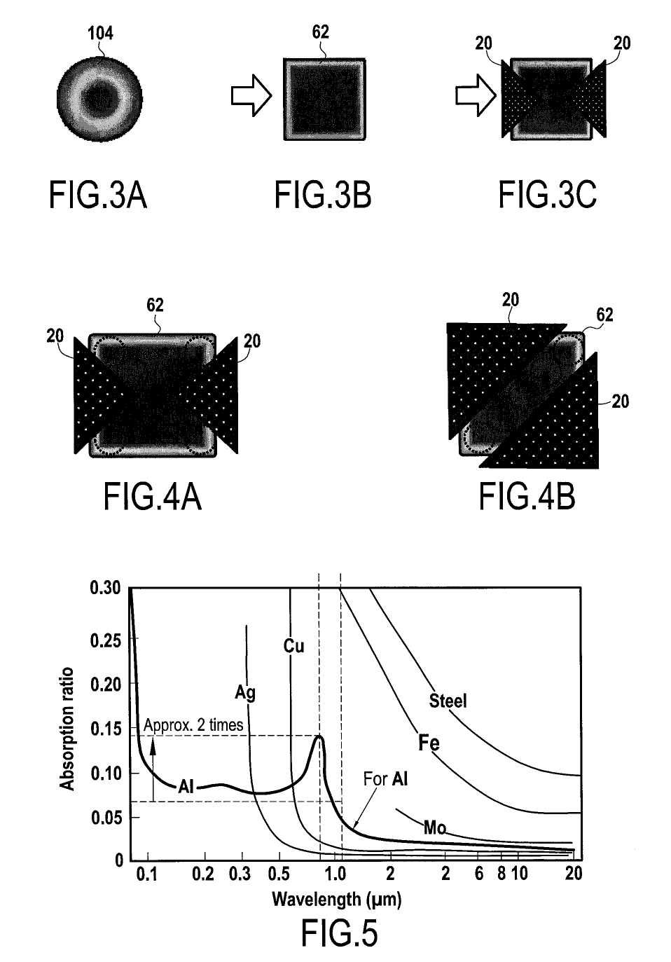

FIG. 3A shows a Gaussian diode laser spot 104, while FIG. 3B shows a resulting shaped laser beam profile 62 following transformation of Gaussian diode laser spot 104 by a beam modifier 5. Beam modifier 5 may comprise one or more optical elements capable of shaping a laser beam provided by laser source 3 into a desired shaped laser beam profile 62. For example, beam modifiers 5 may comprise a one or more diffractive optical elements (e.g., gratings) and/or one or more beam shapers configured to shape an incident laser beam 104 provided by laser source 3 into a top-hat profile (e.g., rectangular top-hat, circular top-hat, square top-hat). Exemplary beam modifier's 5 can be selected from an FBS—Gauss-to-Top Hat Focus Beam Shaper by TOPAG, or a top-hat shaper from HOLO/OR Ltd. One of skill in the art will recognize that these examples are not intended to be limiting and that any other suitable device may be implemented.

FIG. 3C is an exemplary laser shield configuration that may be implemented following shaping of a laser beam by beam modifier 5. One or more shields 20 may be configured to absorb and/or reflect laser light to prevent laser light associated with portions of the shaped laser beam profile from impinging upon target 2. For example, one or more shields 20 may include at least one laser absorbing material (e.g., flocked paper, blackout rubber, etc.) In addition, such laser absorbing material may be bonded to one or more layers of a heat absorbing/dissipating material (e.g., metal) so as to facilitate cooling of the one or more shields 20 as well as to improve their durability.

One or more shields 20 may be positioned between beam modifier 5 and optical elements 7. Alternatively, or in addition, one or more shields 20 may be positioned between optical elements 7 and lens 17. One of skill will recognize that one or more shields may also be positioned between lens 17 and target 2, as desired, the above positioning being exemplary only.

In the current discussion, one or more shields are located between beam modifier 5 and optical elements 7.

One or more laser shields 20 may be formed in any suitable shape to create a desired shielding effect. For example, one or more laser shields 20 may be triangular, rectangular, round, etc.

According to some embodiments, where more than one laser shield 20 is implemented, each laser shield 20 may be of a unique shape with regard to another laser shield 20. For example, a first laser shield 20 may be triangular while a second laser shield is rectangular. Alternatively, all laser shields 20 of the one or more laser shields 20 may be of the same shape.

One of skill in the art will recognize that laser shields 20 may be shaped and implemented based on a particular welding application. For example, according to embodiments of the present disclosure, where a top-hat profile is created by beam modifier 5, two triangular laser shields 20 may be implemented to shield at least 20 percent of the overall shaped beam profile as shown at FIG. 3C. This is example is not intended to be limiting, as one of skill in the art will understand.

One or more laser shields 20 may be adjusted (e.g., using servo motors, positioning devices, etc.) to modify the area of shaped laser beam profile 62 being shielded. For example, during a welding operation, at least one of one or more shields 20 may be adjusted such that at least 20 percent of an area of the shaped laser beam profile is shielded. Such adjustment may include, for example, rotating one or more laser shields 20 to a desired position surrounding the shaped laser profile, radially moving one or more laser shields such that more or less of a shaped profile area is blocked by the one or more laser shields 20, and/or adjusting a longitudinal position of one or more laser shields 20 along the shaped profile. For example, viewing FIG. 3C, one or more laser shields 20 may be adjusted radially (i.e., according to the arrow) to shield a greater area of profile 62.

This adjustment may be carried out based on a position at which the welding is currently taking place. For example, according to some embodiments it may be advantageous to form a linear welding profile (see FIG. 4B) at certain points of the weld line 9, while at other portions of weld line 9, a cross-shaped welding profile (see FIG. 4A) may be desirable.

FIGS. 4A and 4B show exemplary configurations of one or more laser shields 20 with regard to a shaped laser beam profile 62. As shown at FIG. 4B it may be possible to adjust one or more laser shields 20 so as to cause a linear profile to be formed. Depending on a travel direction of laser beam profile 62, such a configuration allows a leading portion of the linear profile to irradiate and heat a portion of target 2 to begin formation of melt pool across a relatively wide area of target 2.

As shown at FIG. 4A, one or more laser shields 20 may also be adjusted to form a cross-shaped profile. This arrangement may permit a beneficial closing and/or sealing of weld line 9, so that a gap to be welded is effectively closed by the narrowing nature of profile 62 moving along the gap.

Directing unit 14 is configured to perform scanning, i.e., directing of one or more output laser beams to a desired location to perform a welding operation. Therefore, directing unit 14 may include a controller 12 and one or more optical elements 7 configured to direct one or more laser beams to and along a weld line 9 of target 2.

Importantly, while controller 12 is discussed within the context of directing unit 14, one of skill in the art will recognize that controller 12 may be integrated with directing unit 14 (i.e., a single structure) or may be provided separately from directing unit 14. One of skill will further recognize that portions of controller 12 may be present with directing unit 14 while other portions of controller 12 are implemented at a location remote from directing unit 14. Any such configurations are intended to be covered by the present disclosure.

Controller 12 may comprise any suitable control device capable of generating and sending commands to directing device 14 to accomplish a desired welding task. For example, controller 12 may comprise a PIC based controller, a RISC based controller, etc. Controller 12 may further be configured to interface with one or more networks, e.g., LAN, WAN, Internet, cellular, etc. so as to receive instructions via the network.

According to embodiments of the present disclosure, one exemplary directing unit 14 and controller 12 combination may comprise a Galvanoscanner, such as, for example, a MIRAMOTION (Y-E data). This exemplary device is not intended to be limiting, however, and any other suitable device may be implemented.

Optical elements 7 may include, for example, one or more mirrors, half mirrors, lenses, mirrored lenses, fibers, etc. suitable for manipulating light. For example, optical elements 7 may include a first mirror 8 positioned at a 45 degree angle relative to a laser beam so as to reflect light perpendicular to the incident laser beam. A scanning mirror 11 may also be provided and configured to direct the laser beam resulting from first mirror 8 in a travel direction T along weld line 9 of target 2. One of skill will recognize that the described configuration is exemplary only, and that more or fewer optical components 7 may be present. For example, one or more lenses 17 and protective coverings may be present to focus output laser beams.

In addition, directing unit 14 may comprise one or more elements designed to manipulate optical elements 7 and/or laser shields 20 in an automated manner. For example, one or more servo motors (not shown) may be provided and configured to rotate, and/or otherwise manipulate optical elements 7 (e.g., scanning mirror 11) and/or one or more shields 20, so as to perform a desired shielding and/or scanning operation during welding.

Systems and methods disclosed herein may be used to weld any suitable material. FIG. 5 is an exemplary graph showing absorption ratios for various materials that may be welded. As can be seen, aluminum welding may be particularly well adapted for the current disclosure based on the nearly double absorption at the wavelengths emitted by diode lasers. This can result in significant cost savings as the energy used for welding materials having higher absorption ratios at suitable wavelengths can be reduced.

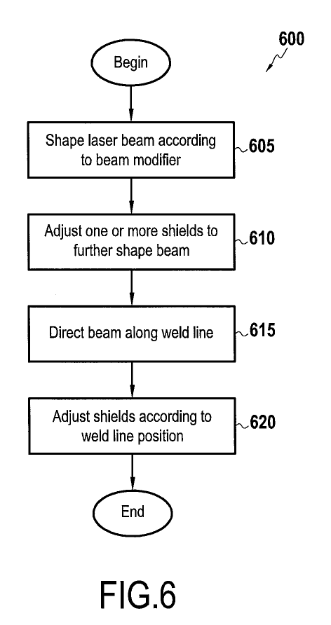

FIG. 6 is a block diagram 600 describing an exemplary method according to embodiments of the present disclosure. According to methods of the present disclosure, a laser beam may be shaped based on a beam modifier 5 implemented in welding system 1 (step 605). For example, where a top-hat beam modifier is implemented, a top-hat laser profile 62 may be generated.

Controller 12 may then cause one or more shields 20 to be adjusted to form a further shaped, shielded laser profile (step 610).

Controller 12 may then begin to scan the shaped and shielded profile 62 along a travel direction T of the weld line 9 of target 2 so as to perform a scanning weld operation (step 615).

During scanning using profile 62, and depending on factors such as, for example, a shape of profile 62, a shape of target 2, etc., adjustments to the one or more shields 20 may be desirable (step 620). For example, where a step is present along a weld line of target 2, it may be desirable to modify profile 62 to accommodate a change in shape of target 2, and controller 12 may then cause adjustment to the one or more shields 20. Of course one of skill will recognize that any other suitable profile may be used. Scanning may then continue, with profile 62 being modified as desired to accommodate the various shapes encountered along the weld line.

An additional benefit of implementing systems and methods of the present disclosure is that ghost beams can be prevented from entering undesirable areas of a target 2, and therefore, the risk of extraneous damage is significantly reduced.

One of skill in the art will recognize that variations may be made to structures and methods described herein. For example, while exemplary embodiments have been discussed using two heat source point collections 60 and 60′, one of skill will recognize that three, four, or more heat source point collections could be implemented depending on a welding task.

In addition, the examples described herein have generally included reference to two laser shields 20. However, one of skill will recognize that the above disclosure is equally applicable where three, four, five, and more laser shields 20 are implemented.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A laser welding system, comprising:
a laser source configured to produce a laser beam having a beam profile;
beam shaping means configured to form a shaped beam profile different than the beam profile; and
shielding means configured to shield at least a portion of the shaped beam profile.

2. The laser welding system according to claim 1, wherein at least 20 percent of the overall shaped beam profile area is shielded by the shielding means.

3. The laser welding system of claim 1, wherein the laser source comprises a diode laser, preferably a diode laser having a spot size between 200 μm and 800 μm, better between 300 and 500 μm.

4. The laser welding system according to claim 1, wherein the laser beam has a wavelength of between 600 nm and 1200 nm.

5. The laser welding system according to claim 1, wherein the beam shaping means comprises a diffractive optical element, and/or the shaped beam profile comprises a top-hat profile.

6. The laser welding system according to claim 1, claims, comprising directing means configured to direct the shielded beam profile along a weld line of a target to perform a laser weld.

7. The laser welding system according to claim 1, wherein the shielded portion of the laser beam profile comprises at least 50 percent of the overall shaped beam profile area.

8. The laser welding system according to claim 1, wherein the shielding means comprises at least one laser absorbing material.

9. The laser welding system according to claim 1, wherein a shape of the shielding means is selected from among triangular and rectangular.

10. The laser welding system according to claim 1, wherein the shielding means comprises two shields of triangular shape.

11. The laser welding system according to claim 1, wherein the shielding means is configured to form a shielded beam profile selected from one of a cross or a line.

12. The laser welding system according to claim 1, comprising adjusting means configured to adjust the shielding means based on a location along a weld line of a target.

13. A method for laser welding, comprising:
shaping a laser beam to form a desired laser beam profile;
adjusting at least one laser shield such that a portion of an area of the shaped laser beam profile is shielded to form a welding profile; and
directing the welding profile in a travel direction along a weld line of a target so as to perform a welding operation.

14. The method according to claim 13, wherein the portion is at least 20 percent of the overall shaped beam profile.

15. The laser welding method according to claim 13, wherein the adjusting results in further shaping of the desired laser beam profile.

16. The laser welding method according to claim 13, wherein the shaping results in formation of a top-hat profile.

17. The laser welding method according to claim 13, wherein the target is an elongate battery case and cover, preferably for a lithium ion battery.

18. The laser welding method according to claim 13, wherein the adjusting is carried out based on a location along the weld line.

19. A laser welding system, comprising:
a laser source configured to produce a laser beam having a beam profile;
a beam shaper configured to form a shaped beam profile different from the beam profile of the laser beam; and
at least one laser shield configured to shield at least a portion of the shaped beam profile.

20. The laser welding system according to claim 19, wherein at least 20 percent of the overall shaped beam profile area is shielded by the at least one laser shield.

21. The laser welding system of claim 19, wherein the laser source comprises a diode laser.

22. The laser welding system of claim 21, wherein the diode laser has a spot size between 200 μm and 800 μm.

23. The laser welding system according to claim 19, wherein the laser beam has a wavelength of between 600 nm and 1200 nm.

24. The laser welding system according to claim 19, wherein the beam shaper comprises a diffractive optical element, and the shaped beam profile is a top-hat profile.

25. The laser welding system according to claim 19, comprising one or more optical elements and a controller configured to direct the shielded beam profile along a weld line of a target to perform a laser weld.

26. The laser welding system according to claim 19, wherein the shielded portion of the laser beam profile comprises at least 50 percent of the overall shaped beam profile area.

27. The laser welding system according to claim 19, wherein the at least one laser shield comprises at least one laser absorbing material.

28. The laser welding system according to claim 19, wherein a shape of the at least one laser shield is selected from among triangular and rectangular.

29. The laser welding system according to claim 28, wherein the at least one laser shield comprises two laser shields of triangular shape.

30. The laser welding system according to claim 19, wherein the at least one laser shield is configured to form a shielded beam profile selected from one of a cross or a line.

31. The laser welding system according to claim 19, comprising an adjuster configured to adjust the at least one laser shield based on a location along a weld line of a target.
